(19) United States
(12) Patent Application Publication
(10) Pub. No.: US 2014/0224354 A1
(43) Pub. Date: Aug. 14, 2014

(54) Drain

(71) Applicant: Eddie Willburn, Amarillo, TX (US)

(72) Inventor: Eddie Willburn, Amarillo, TX (US)

(21) Appl. No.: 13/764,783

(22) Filed: Feb. 11, 2013

(51) Int. Cl. F16L 5/02

(52) U.S. Cl. CPC F16L 5/02
USPC 137/362

(57) ABSTRACT

An improved drain comprising a drain fitting, an extension having an exterior height, a squash plate, and a gasket. Said extension attaching to a drain pipe of a drain. Said drain fitting between a floor and a drain pan of said drain. Said gasket sealing between said extension and said drain pipe of said drain. Said gasket having a one or more ribs about an interior surface of said gasket. and Said squash plate attaching to a top portion of said extension.

### BACKGROUND

This filing claims priority to U.S. Provisional Patent Application No. 61/597,167 filed on Feb. 10, 2012. It is also a continuation in part of U.S. patent application Ser. No. 13/043,261 filed on Mar. 8, 2011 which bears one inventor in common with the present application.

This disclosure relates generally to an improved drain. Currently, when a user installs a drain, it is often the case that said user must substantially destroy a floor to access and replace said drain. In one embodiment, said user much jackhammer said floor to gain access to a drain pipe and/or a drain pan for said installation. In one embodiment, a portion of said drain pipe must be cut in order to remove an old or broken drain to be replaced. Alternatively, in one embodiment, current embodiments of drains are not long enough to reach said drain pipe after it has been cut. As such, more of said floor must be cut away in order to access an uncut portion of said drain pipe.

Said current embodiment, taken either singularly or in combination with other current embodiments, is seen to describe the instant disclosure as claimed. Accordingly, an improved drain would be advantageous.

### SUMMARY

An improved drain comprising a drain fitting, an extension having an exterior height, a squash plate, and a gasket. Said extension attaching to a drain pipe of a drain. Said drain fitting between a floor and a drain pan of said drain. Said gasket sealing between said extension and said drain pipe of said drain. Said gasket having a one or more ribs about an interior surface of said gasket. and Said squash plate attaching to a top portion of said extension.

### BRIEF DESCRIPTION OF THE DRAWINGS

FIGS. 1A, 1B and 1C illustrate a perspective overview and two elevated front side views of an improved drain installed into a floor, a drain pan and a drain pipe; wherein, said floor and said drain pan are illustrated in a cross-section view.

FIG. 1C illustrates a detailed elevated front view of said improved drain installed between said floor and said drain pan.

FIG. 2 illustrates a cross-section elevated view of said extension, said squash plate, said gasket and said drain pipe.

FIGS. 3A, 3B, 3C and 3D illustrate a perspective overview, an elevated top view, an elevated front view, and a cross-section elevated front view of said extension.

FIGS. 4A, 4B, 4C and 4D illustrate a perspective overview, an elevated top view, an elevated front view and a cross-section of an elevated front view of said squash plate.

FIGS. 5A and 5B illustrate a cross-section view of a perspective overview and perspective under view of said squash plate.

FIGS. 6A and 6B illustrate a perspective overview and an elevated top view of said drain fitting.

FIGS. 7A, 7B and 7C illustrate a perspective overview, an elevated front view and a cross-section elevated front view of said gasket.

### DETAILED DESCRIPTION

Described herein is an improved drain. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

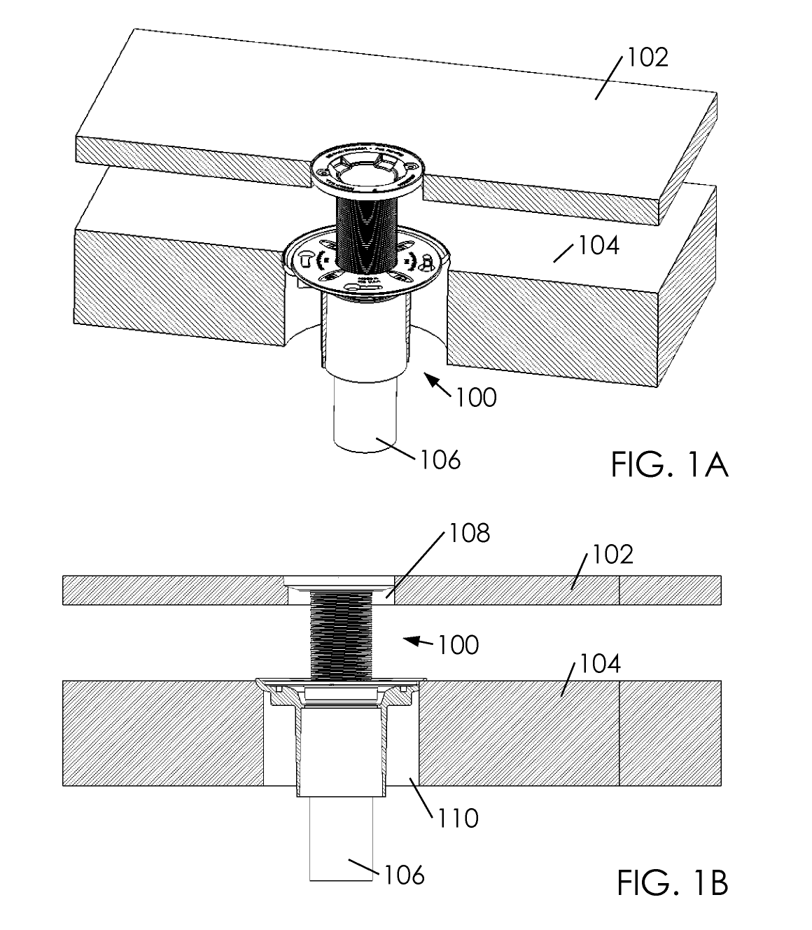

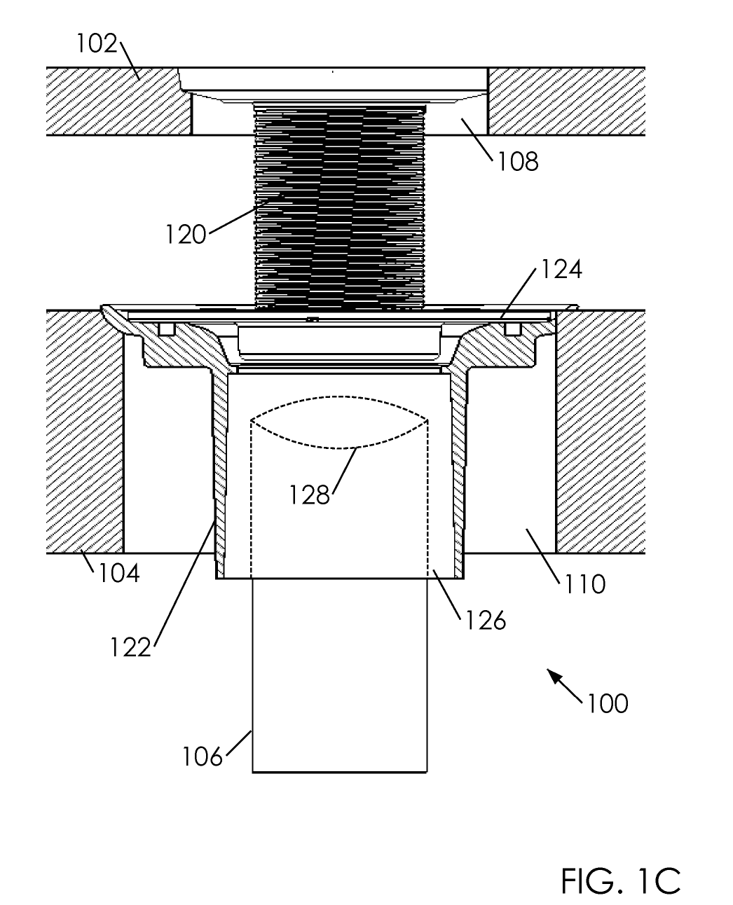

FIGS. 1A, 1B and 1C illustrate a perspective overview and two elevated front side views of an improved drain 100 installed into a floor 102, a drain pan 104 and a drain pipe 106; wherein, said floor 102 and said drain pan 104 are illustrated in a cross-section view. In one embodiment, said improved drain 100 can (generally) funnel liquids from above said floor 102 into said drain pipe 106. In one embodiment, said floor 102 can comprise a floor aperture 108 and said drain pan 104 can comprise a drain aperture 110. In one embodiment, a fluid (such as water or waste water) can drain from above said floor 102 through said floor aperture 108 down to said drain aperture 110 and out said drain pipe 106. In one embodiment, said improved drain 100 can be arranged so as to ensure said fluid does not get caught between said floor 102 and said drain pan 104. In one embodiment, said

FIG. 1C illustrates a detailed elevated front view of said improved drain 100 installed between said floor 102 and said drain pan 104. In one embodiment, said improved drain 100 can comprise a drain fitting 120, an extension 122, a squash plate 124 and a gasket 126. In one embodiment, said drain fitting 120 can fit between said floor 102 and said drain pan 104. In one embodiment, said drain fitting 120 can attach to a portion of said extension 122. In one embodiment, said gasket 126 can fit around a portion of said drain pipe 106. In one embodiment, said gasket 126 can fit between a portion of said extension 122 and said drain pipe 106. In one embodiment, said gasket 126 can ensure a fluid connection between and keep a seal between said extension 122 and said drain pipe 106. In one embodiment, said squash plate 124 can fit between said extension 122 and said drain fitting 120.

Currently, when a user installs a drain, it is often the case that said user must substantially destroy said floor 102 to access and replace said drain. In one embodiment, said user much jackhammer said floor 102 to gain access to said drain pipe 106 and/or said drain pan 104 for said installation. In one embodiment, a portion of said drain pipe 106 must be cut in order to remove an old or broken drain to be replaced. Alternatively, in many embodiments, replacement drains are not long enough to reach said drain pipe 106 after it has been cut. As such, more of said floor 102 must be cut away in order to access an uncut portion of said drain pipe 106. In one embodiment, said improved drain 100 can be used to improve replacing a drain. For example, in one embodiment, said extension 122 can comprise a length long enough to reach down and wrap around a portion of said drain pipe 106, even where said drain pipe 106 can be cut below said drain pan 104. In one embodiment, said drain pipe 106 can comprise a cut end 128. In one embodiment, said extension 122 can be long enough to reach below said drain pan 104 and wrap completely around said cut end 128 of said drain pipe 106. In one embodiment, said gasket 126 can create a seal around said cut end 128 and allow a fluid connection within said extension 122 into said cut end 128 and keep said fluid from seeping into said drain aperture 110 outside of said drain pipe 106.

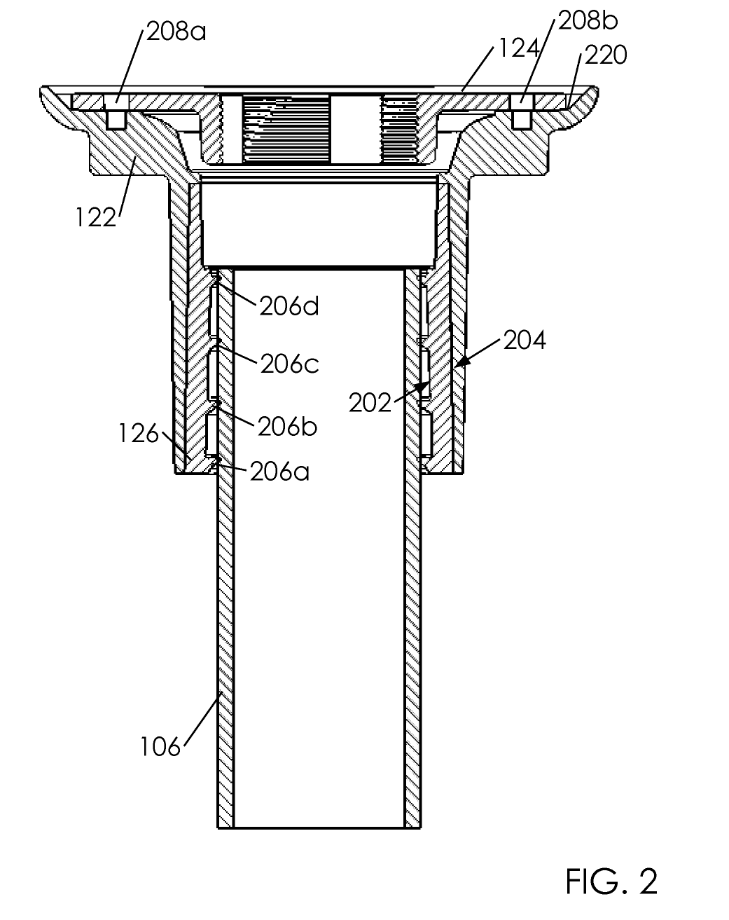

FIG. 2 illustrates a cross-section elevated view of said extension 122, said squash plate 124, said gasket 126 and said drain pipe 106. In one embodiment, said gasket 126 can comprise a substantially cylindrical member having an interior surface 202 and an exterior surface 204. In one embodiment, said interior surface 202 can comprise a one or more ribs. In one embodiment, said one or more ribs can comprise a first rib 206a, a second rib 206b, a third rib 206c and a fourth rib 206d. In one embodiment, one or more of said one or more ribs can create a seal with said drain pipe 106 and said exterior surface 204 can create a seal with a portion of said extension 122. In one embodiment, only one of said one or more ribs are necessary to create an adequate seal between said drain pipe 106 and said gasket 126. [TO COME: discussion of blocking odor]. In one embodiment, said squash plate 124 and said extension 122 can comprise a plastic, such as as TPU 20-40 a durometer. In one embodiment, said squash plate 124 can attach to said extension 122 at a one or more fastener apertures. In one embodiment, said one or more fastener apertures can comprise threaded apertures capable of receiving a portion of a threaded fastener as is known in the art. In one embodiment, said one or more fastener apertures can comprise a first fastener aperture 208a, a second fastener aperture 208b, a third fastener aperture 208c (not illustrated here) and a fourth fastener aperture 208d (not illustrated here). In one embodiment, said squash plate 124 can comprise a one or more fastener apertures that align with said one or more fastener apertures of said extension 122 (as will be discussed and/or illustrated below).

In one embodiment, a gap 220 can be arranged between said squash plate 124 and said extension 122. In one embodiment, said gap 220 can comprise 20,000^{th} of an inch between said parts.

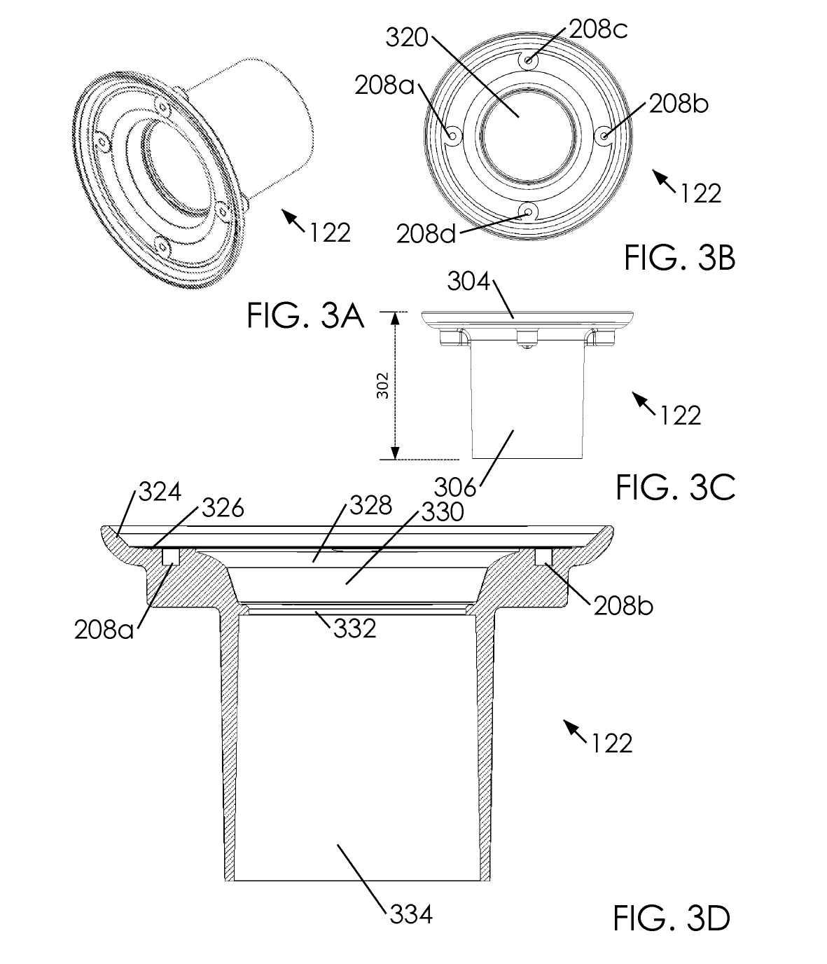

FIGS. 3A, 3B, 3C and 3D illustrate a perspective overview, an elevated top view, an elevated front view, and a cross-section elevated front view of said extension 122. In one embodiment, said extension 122 can comprise an exterior height 302. In one embodiment, said extension 122 can comprise a head portion 304 and a body portion 306. In one embodiment, said extension 122 can comprise a center aperture 320. In one embodiment, said center aperture 320 can comprise a one or more stages from said head portion 304 to said body portion 306. In one embodiment, said one or more stages can comprise a first stage 324 at a lip around said head portion 304, a second stage which can be substantially flat, a third stage 328 and a fourth stage 330 leading to a lip 332 above a gasket aperture 334. In one embodiment, said one or more stages can gradually decrease in diameter as between said head portion 304 and said body portion 306. Accordingly, said center aperture 320 can cause a fluid to naturally drain from said head portion 304 toward said body portion 306.

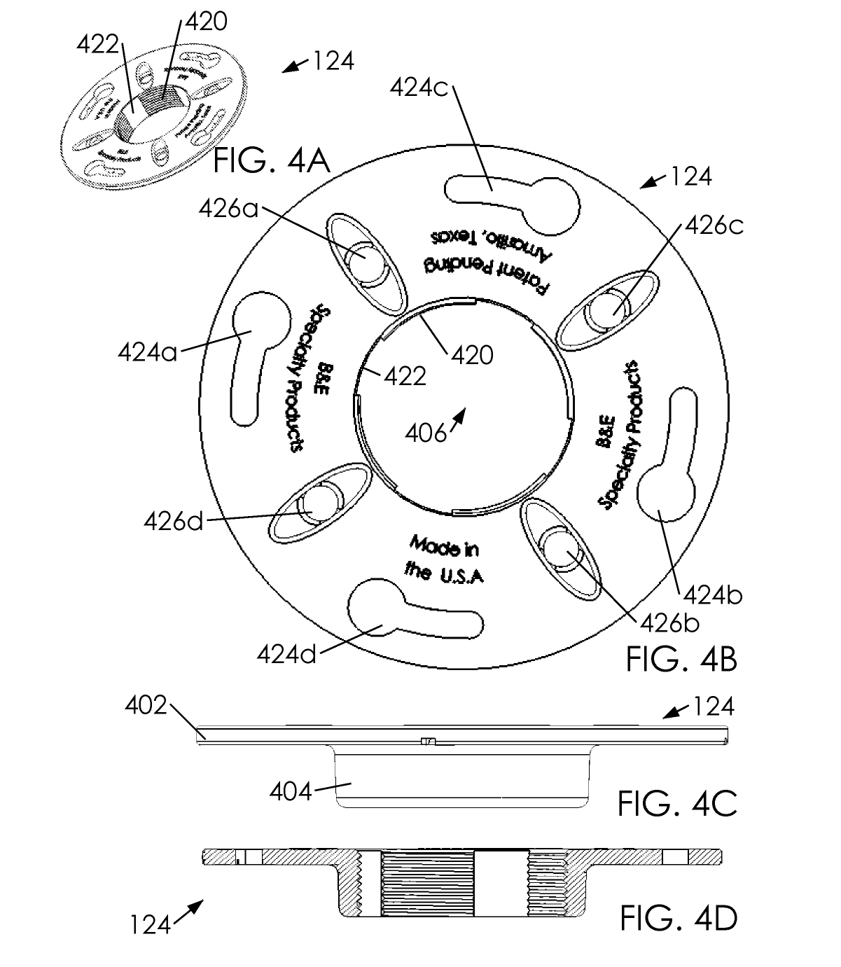

FIGS. 4A, 4B, 4C and 4D illustrate a perspective overview, an elevated top view, an elevated front view and a cross-section of an elevated front view of said squash plate 124. In one embodiment, said squash plate 124 can comprise a first portion 402 and a second portion 404. In one embodiment, said first portion 402 can comprise a top portion and said second portion 404 can comprise a bottom portion of said squash plate 124. In one embodiment, said first portion 402 can attach to a portion of said extension 122. In one embodiment, said squash plate 124 can comprise a center aperture 406 along a vertical axis at its center portion. That is, said one or more stages can comprise an increasing drain angle toward the gasket. In one embodiment, said increased drain angle of one or more of said one or more stages can be 18 degrees. In one embodiment, said increased drain angle can cause said fluid to cascade.

In one embodiment, said squash plate 124 can comprise an internal threading 420 about said center aperture 406. In one embodiment, said internal threading 420 can comprise a one or more gaps 422 between said internal threading 420 which allow said fluid to flow through said one or more gaps 422 where said internal threading 420 might have otherwise blocked said fluid from penetrating said squash plate 124. In one embodiment, said squash plate 124 can comprise a one or more apertures capable of aligning with and allowing one or more fastners to attach said squash plate 124 to said extension 122. In one embodiment, said one or more apertures in said squash plate 124 can comprise a one or more banjo slots (such as a first banjo slot 424a, a second banjo slot 424b, a third banjo slot 424c and a fourth banjo slot 424d). In one embodiment, said one or more banjo slots can align with said one or more fastener apertures of said extension 122, as known in the art.

In one embodiment, said squash plate 124 can further comprise a one or more weep holes (such as a first weep hole 426a, a second weep hole 426b, a third weep hole 426c and a fourth weep hole 426d). In one embodiment, said one or more weep holes can be arranged around said first portion 402 of said squash plate 124. In one embodiment, said squash plate 124 can allow a fluid to weep through said squash plate 124 at said first portion 402.

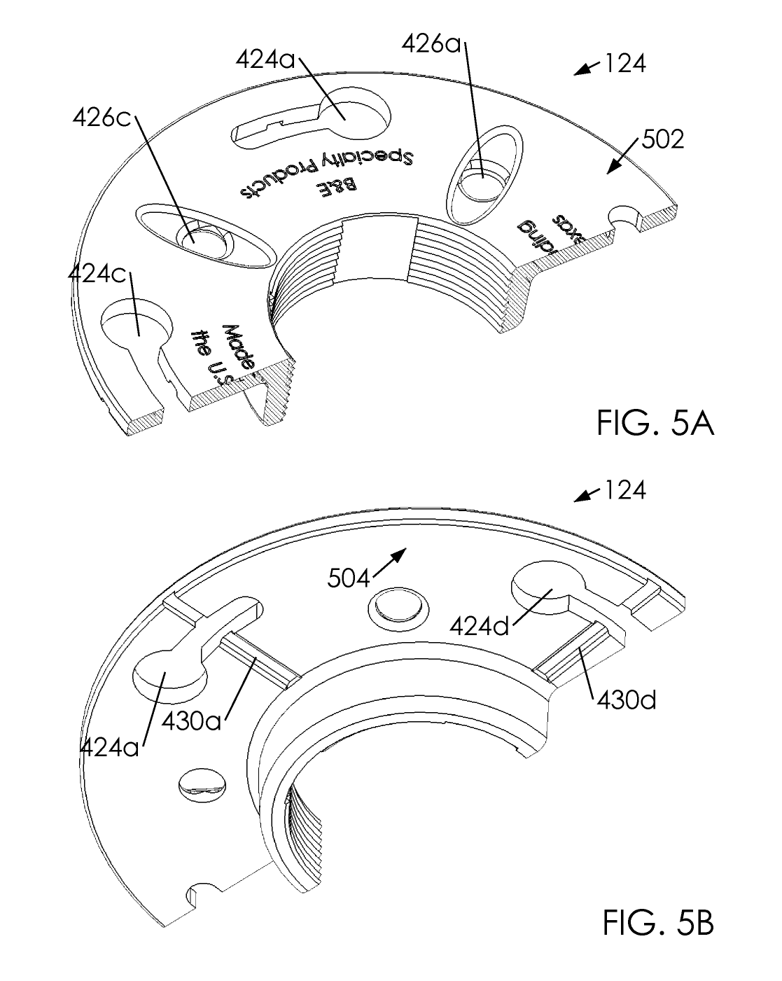

FIGS. 5A and 5B illustrate a cross-section view of a perspective overview and perspective under view of said squash plate 124. Said first portion 402 can comprise a top side 502 and a bottom side 504. In one embodiment, said one or more banjo slots each comprise one of said one or more weep holes. For example, in one embodiment, said first banjo slot 424a can comprise a first banjo weep hole 430a, said second banjo slot 424b can comprise a second banjo weep hole 430b, said third banjo slot 424c can comprise a third banjo weep hole 430c, and said fourth banjo slot 424d can comprise a fourth banjo weep hole 430d. Thus, in one embodiment said squash plate 124 can allow said fluid to move through said squash plate 124 through said one or more banjo slots and/or said center aperture 406.

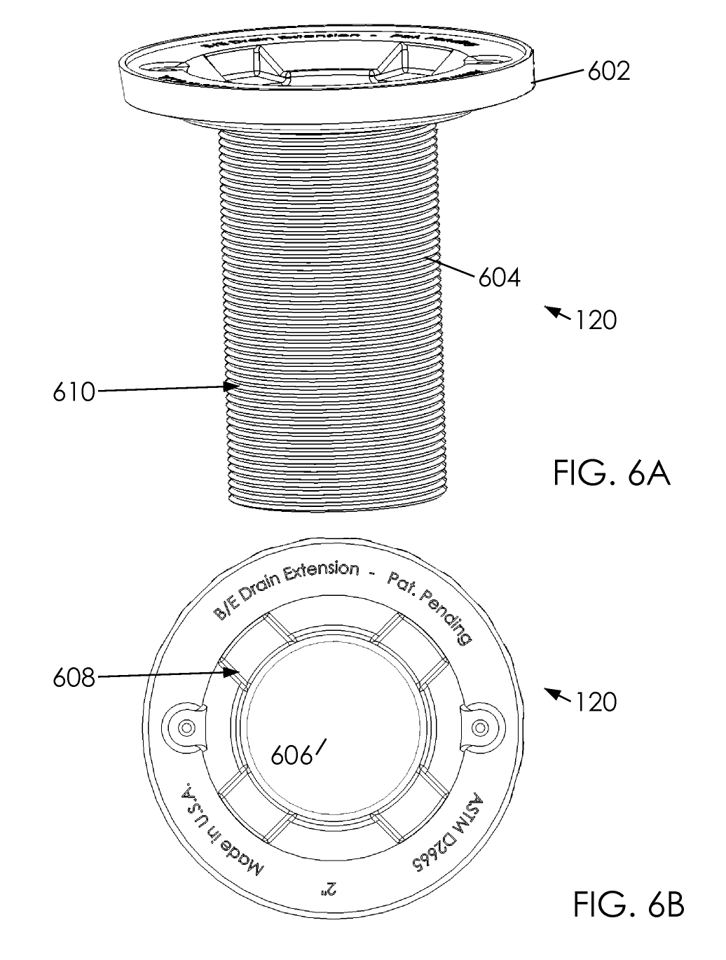

FIGS. 6A and 6B illustrate a perspective overview and an elevated top view of said drain fitting 120. In one embodiment, said drain fitting 120 can comprise a head portion 602, a body portion 604, a center aperture 606, and a one or more drain plate receivers 608. In one embodiment, said body portion 604 can comprise an external threading 610. In one embodiment, said head portion 602 can align substantially horizontally with said floor 102. In one embodiment, said head portion 602 can receive a drain plate (not illustrated) at said one or more drain plate receivers 608. In one embodiment, said drain plate is capable of catching many non-fluid objects prior to entry into said drain fitting 120, as is known in the art. In one embodiment, said head portion 602 can be wider than said body portion 604. In one embodiment, aid drain fitting 120 can be substantially round as rotated about said center aperture 606. In one embodiment, said fluid can channel through said 606. In one embodiment, said external threading 610 can attach to said internal threading 420.

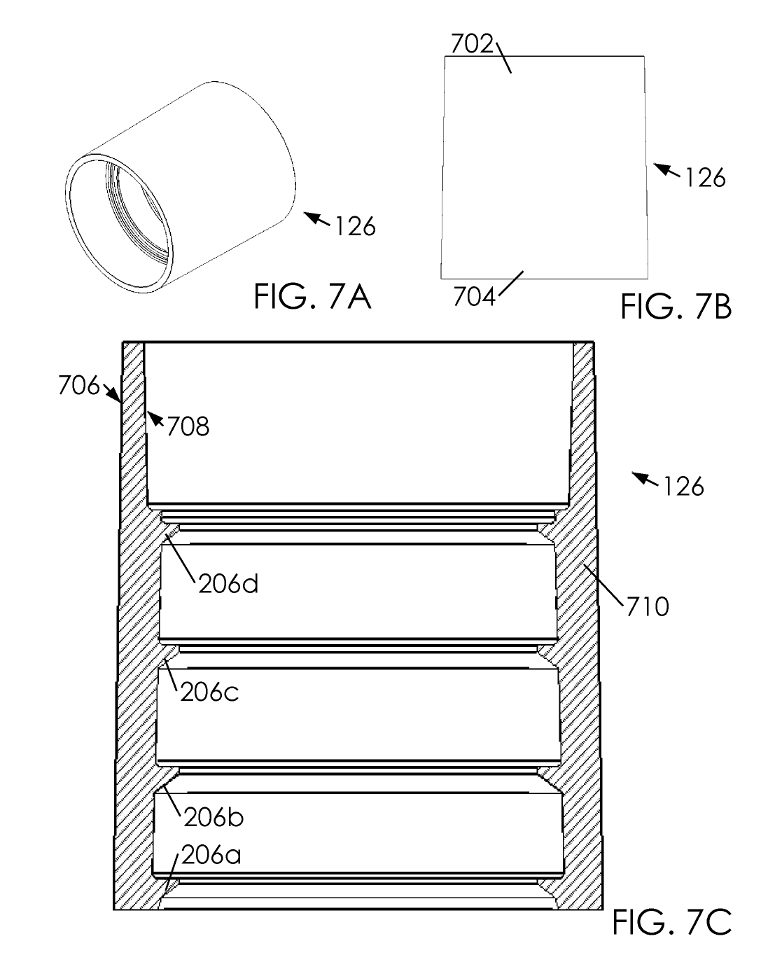

FIGS. 7A, 7B and 7C illustrate a perspective overview, an elevated front view and a cross-section elevated front view of said gasket 126. In one embodiment, said gasket 126 can comprise a top end 702, a bottom end 704, an exterior surface 706 and an interior surface 708. In one embodiment, said one or more ribs can line said interior surface 708, as shown and described. In one embodiment, said gasket 126 can comprise a wall 710; wherein, said wall 710 can gradually thicken as starting at said top end 702 and growing thicker toward said bottom end 704. In one embodiment, said gasket 126 can comprise a 1 degree taper within said extension 122. In one embodiment, said gasket 126 can be designed to push down on the drain pipe 106. For example, in one embodiment, each of said one or more ribs can comprise an upward deflection and a downward deflection; wherein, a downward fluid pressure can cause a said gasket 126 to tighten on said drain pipe 106.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A improved drain comprising:
a drain fitting, an extension having an exterior height, a squash plate, and a gasket;
wherein,
said extension attaching to a drain pipe of a drain;
said drain fitting between a floor and a drain pan of said drain;
said gasket sealing between said extension and said drain pipe of said drain;
said gasket having a one or more ribs about an interior surface of said gasket; and
said squash plate attaching to a top portion of said extension.
